(19) United States
(12) Patent Application Publication
(10) Pub. No.: US 2007/0121944 A1
(43) Pub. Date: May 31, 2007

(54) TRANSMITTER USING CHAOTIC SIGNAL

(75) Inventors: Kwang Du LEE, JEONLANAM-DO (KR); Hak Sun KIM, DAEJEON (KR); Chang Soo YANG, KYUNGKI-DO (KR); Sang Gyu PARK, KYUNGKI-DO (KR); Tah Joon PARK, KYUNGKI-DO (KR); Kyu Hwan AN, SEOUL (KR)

Correspondence Address: LOWE HAUPTMAN BERNER, LLP, 1700 DIAGONAL ROAD, SUITE 300, ALEXANDRIA, VA, 22314, US

(73) Assignee: SAMSUNG ELECTRO-MECHANICS CO., LTD., KYUNGKI-DO (KR)

(21) Appl. No.: 11/466,397

(22) Filed: Aug. 22, 2006

(30) Foreign Application Priority Data
Aug. 23, 2005 (KR) 10-2005-0077369

(51) Int. Cl. H04L 9/00

(52) U.S. Cl. 380/263

(57) ABSTRACT

The invention provides a transmitter using a chaotic signal which turns on/off a supply voltage of a chaotic signal generator in accordance with a transmitted digital data signal, without requiring a separate modulator for combining the chaotic signal and the digital data signal. The transmitter uses a chaotic signal for modulating a predetermined digital data to transmit. A chaotic signal generator turns on to generate the chaotic signal when a supply voltage is supplied and turns off when the supply voltage is cut off. A supply voltage switch supplies/cuts off the supply voltage to/from the chaotic signal generator in accordance with the digital data. Further, the supply voltage of the chaotic signal generator is supplied/cut off in accordance with the digital data so that an output from the chaotic signal generator is a modulated signal of the digital data.

### CLAIM OF PRIORITY

This application claims the benefit of Korean Patent Application No. 2005-77369 filed on Aug. 23, 2005 in the Korean Intellectual Property Office, the disclosure of which is incorporated herein by reference.

### BACKGROUND OF THE INVENTION

1. Field of the Invention

The present invention relates to a transmitter for transmitting a digital data using a chaotic signal of a broad band. More particularly, the present invention relates to a transmitter which turns on/off a supply voltage of a chaotic signal generator in accordance with a digital data signal, thereby not requiring a separate modulator for combining the chaotic signal and the digital data signal.

2. Description of the Related Art

In general, a chaotic signal is characterized as an aperiodic signal with no phase, and a wide band signal. A typical periodic signal has a regular phase in accordance with time and thus may be distorted or cancelled when an interference signal of an antiphase is added. However, a chaotic signal has no clear phase so that it does not interfere with any antiphase signals or proximal interference signals which are even induced thereto. This serves to protect information in a data signal. Also, at a frequency domain, the chaotic signal is uniformly sized regardless of a cycle in a wide band and exhibits superior energy efficiency.

Such a chaotic signal can be made suitable for information transmission and utilized as a carrier wave. This eliminates a need for a separate coding such as time hopping in a modem due to fewer spikes, also allowing simple configuration of a transmitter and/or a receiver via On-Off Keying (OOK). Furthermore, a modulation method using the chaotic signal ensures control of the chaotic signal through a small change in the system, thereby achieving a communication system with higher power efficiency. Also, the chaotic signal fundamentally has a continuous spectrum which expands into a wider frequency bandwidth, thus applicable to the modulation where an energy spectrum is required to have no loss throughout the wide bandwidth.

FIG. 1 is a block diagram illustrating a conventional transmitter using a chaotic signal. As shown in FIG. 1, the conventional transmitter using the chaotic signal includes a chaotic signal generator 11, a band pass filter 12, a modulator 13, an amplifier 14 and an antenna ANT. The chaotic signal generator 11 generates a chaotic signal. The band pass filter 12 prevents the chaotic signal from influencing a system of another frequency band while blocking a proximal interference signal. The modulator 13 multiplies a continuous transmission data to be transmitted by the chaotic signal, thereby modulating the multiplied result via an OOK method. The amplifier 14 amplifies a signal modulated from the modulator at a given gain. Also, the antenna ANT transmits the modulated signal amplified by the amplifier 14 to a free space.

In such a conventional transmitter using the chaotic signal, the chaotic signal generator 11 is required to stay on continuously while transmitting a transmission data, thus consuming a considerable amount of power. In addition, the chaotic signal, when directly modulated via the modulator in the form of OOK, causes the modulator 13 to experience a relatively great amount of power consumption. Therefore, the conventional transmitter using the chaotic signal is extremely disadvantageous for a wireless mobile telecommunication where low power is in demand.

Moreover, impedance altered by on/off of the modulator 13 in the form of OOK triggers a spike phenomenon 21 as shown in an output waveform of the conventional transmitter of FIG. 2. This adversely affects an overall transmission/reception system.

Also, when a transmission data is ‘0’ (out of ‘0’ and ‘1’), a signal from the modulator 13 is limitedly isolated, thus experiencing coupling. Disadvantageously, this leads to a failed output of ‘0’ as shown in reference sign 22 of FIG. 2. This phenomenon, which results from parasitic capacitance-induced coupling, narrows a dynamic range of the signal and potentially degrades reception sensitivity of a receiver.

### SUMMARY OF THE INVENTION

The present invention has been made to solve the foregoing problems of the prior art and therefore an object according to certain embodiments of the present invention is to provide a transmitter using a chaotic signal which turns on/off a supply voltage supplied to a chaotic signal generator in accordance with a value of a transmission data to be transmitted so that the chaotic signal outputted from the chaotic signal generator is a modulated signal in accordance with the transmission data.

According to an aspect of the invention for realizing the object, there is provided a transmitter using a chaotic signal for modulating a predetermined digital data to transmit, the transmitter comprising: a chaotic signal generator for turning on to generate the chaotic signal when a supply voltage is supplied, and turning off when the supply voltage is cut off; and a supply voltage switch for supplying/cutting off the supply voltage to/from the chaotic signal generator in accordance with the digital data; wherein the supply voltage of the chaotic signal generator is supplied/cut off in accordance with the digital data so that an output from the chaotic signal generator is a modulated signal of the digital data.

According to an embodiment of the invention, the chaotic signal generator comprises: a plurality of signal generators each for generating a signal composed of a fundamental wave and a plurality of harmonic waves of the fundamental wave, the fundamental waves of the signal generators different from each other; and a mixer for mixing the signals generated from the signal generator to generate a chaotic signal having a sum frequency of the signals and the harmonic waves of the signals.

Also, according to an embodiment of the invention, the supply voltage switch comprises: an input terminal for receiving the digital data transmitted; an output terminal for supplying a switched power supply to the chaotic signal generator; a first transistor having a gate connected to the input terminal, a drain connected to the supply voltage and a source connected to the output terminal; a second transistor having a drain connected to the output terminal and a source connected to a ground; and an inverter connected between the input terminal and a gate of the second transistor.

The transmitter using the chaotic signal according to an embodiment of the invention further comprises a band pass filter for passing a signal component of a preset band out of the chaotic signal generated from the chaotic signal generator; and an amplifier for amplifying the signal component at a given gain.

At this time, preferably, the band pass filter is formed integrally with the amplifier. The integral structure of the band pass filter and amplifier comprises a cascode amplifier structure including a plurality of amplifying stages, wherein each of the amplifying stages comprises an amplifying part including a transistor, and a band pass filtering part including a capacitor and an inductor capacitively coupled to the amplifying part.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram illustrating a conventional transmitter using a chaotic signal;

FIG. 2 is a waveform diagram illustrating an output signal outputted from the conventional transmitter using a chaotic signal;

FIG. 3 is a block diagram illustrating a transmitter using a chaotic signal according to an embodiment of the invention;

FIG. 4 is a block diagram illustrating a chaotic signal generator employed in a transmitter using a chaotic signal according to another embodiment of the invention;

FIGS. 5a and 5b are circuit diagrams illustrating first and second signal generators of the chaotic signal generator of FIG. 4, respectively.

FIG. 6 is a configuration diagram illustrating an exemplary supply voltage switch employed in a transmitter using a chaotic signal according to further another embodiment of the invention;

FIG. 7 is a waveform diagram illustrating an output waveform of the chaotic signal generator in a transmitter using a chaotic signal according to further another embodiment of the invention;

FIG. 8a is a detailed circuit diagram illustrating an exemplary integral band pass filter and amplifier according to further another embodiment of the invention; and

FIG. 8b is an equivalent circuit diagram illustrating an exemplary integral band pass filter and amplifier according to still another embodiment of the invention.

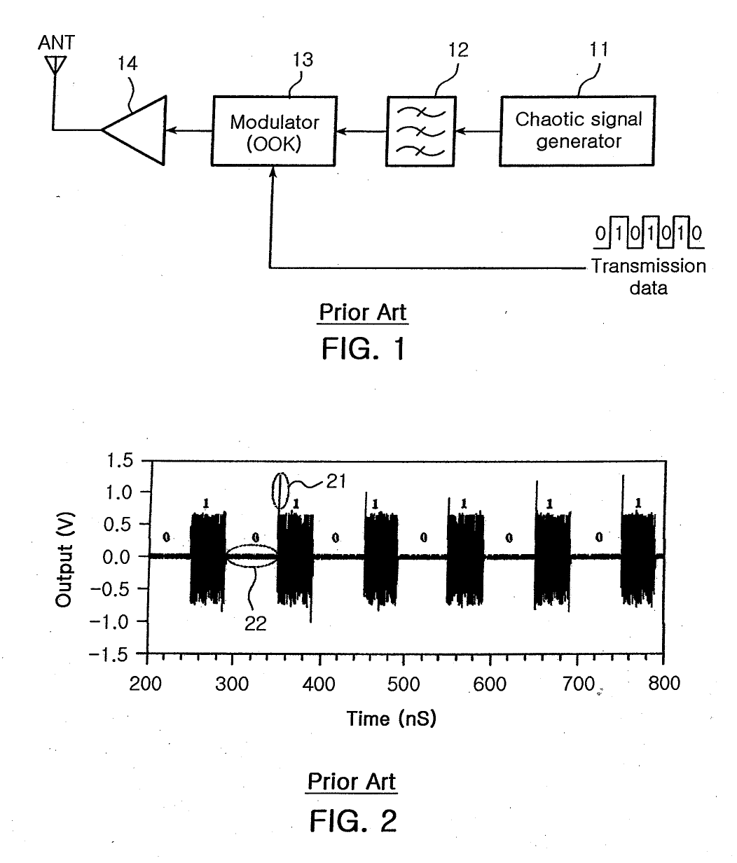

### DETAILED DESCRIPTION OF THE PREFERRED EMBODIMENT

The present invention now will be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the shapes and dimensions may be exaggerated for clarity, and the same reference signs are used to designate the same or similar components throughout.

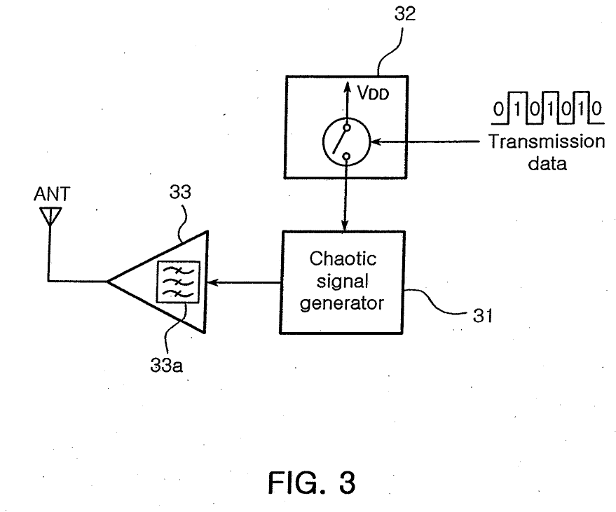

FIG. 3 is a block diagram illustrating a transmitter using a chaotic signal according to an embodiment of the invention.

Referring to FIG. 3, the transmitter using the chaotic signal according to this embodiment includes a chaotic signal generator 31 and a supply voltage switch 32. The chaotic signal generator 31 is turned on to generate the chaotic signal when a supply voltage VDD is supplied. Also, the chaotic signal generator 31 is turned off when the power supply VDD is cut off. The supply voltage switch 32 supplies/cuts off the supply voltage VDD to/from the chaotic signal generator 31 in accordance with a digital transmission data inputted. In addition, the transmitter further includes a band pass filter 33a and an amplifier 33, which are integrally structured.

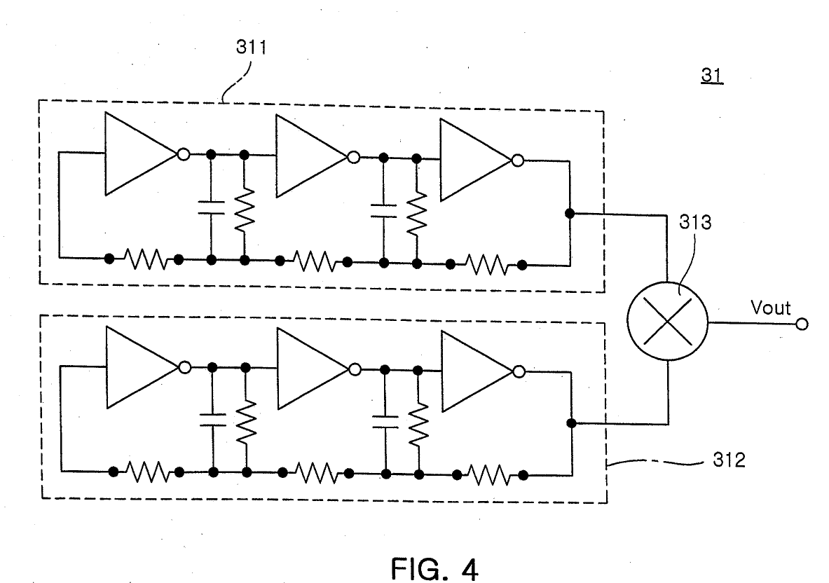

The chaotic signal generator 31 is disclosed in detail in Korea Patent Application No. 2005-60391 filed by the same applicant (or the assignee of this application). FIG. 4 illustrates a structure of the chaotic signal generator proposed in the document. FIG. 4 illustrates the exemplary chaotic signal generator comprised of a first signal generator and a second signal generator. However, the present invention is not limited thereto and it is readily apparent to those skilled in the art that the number of the signal generators can be varied according to the applicable embodiment of the invention.

Referring to FIG. 4, the chaotic signal generator according to this embodiment includes a first signal generator 311, a second signal generator 312, and a mixer 313. The first signal generator 311 generates a first signal including a first fundamental wave and a plurality of harmonic waves of the first fundamental wave. Likewise, the second signal generator 312 generates a second signal including a second fundamental wave and a plurality of harmonic waves of the second fundamental wave. The mixer 313 mixes the first signal from the first signal generator 311 with the second signal from the second signal generator 312 to generate a chaotic signal having a sum frequency of the first and second signals and the harmonic waves of the first and second signals.

The first signal from the first signal generator 311 is a square wave signal including the first fundamental wave and the harmonic waves of the first fundamental wave. The second signal from the second signal generator 312 is also a square wave signal including the second fundamental wave and the harmonic waves of the second fundamental wave. Here, the first and second signals may be a pulse, triangular or sawtooth signal.

Each of the first and second signal generators 311 and 312 generates a square wave signal with a plurality of frequencies. Thus, the each of the first and second generators may be a ring type oscillator suited to generate such a square wave signal.

Preferably, the frequency of the first fundamental wave from the first signal generator 311 is set different from the frequency of the second fundamental wave from the second signal generator 312 to generate the chaotic signal with the plurality of frequencies.

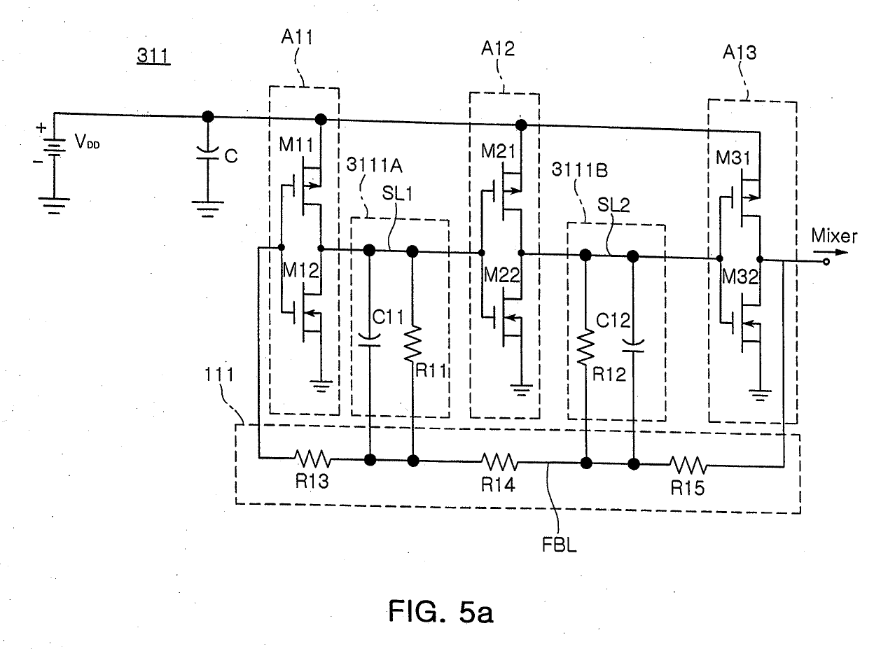

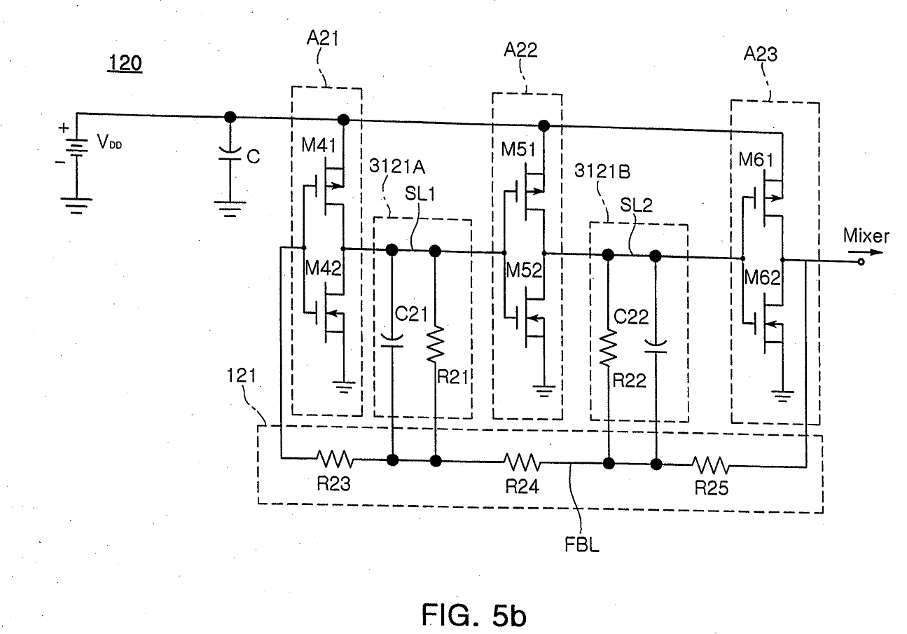

Further, the first and second generators 311 and 312 may be configured into a substantially equal circuit. However, the first fundamental wave of the first signal generator 311 is set different from the second fundamental wave of the second signal generator 312. FIGS. 5a and 5b illustrate an exemplary configuration of the first signal generator 311 and the second signal generator 312.

FIGS. 5a and 5b are circuit diagrams illustrating the first and second signal generators. FIG. 5a is a circuit diagram of the first signal generator of FIG. 4, and FIG. 5b is a circuit diagram of the second signal generator of FIG. 4.

Referring to FIG. 5a, the first signal generator 311 of this embodiment includes a plurality of inverter-type amplifiers A11 to A13, a feedback circuit 111 and delay circuits 3111A and 3111B. The inverter-type amplifiers A11 to A13 are connected in series. The feedback circuit 111 has a feedback line FBL commonly connected to input terminals and output terminals of the inverter-type amplifiers A11 to A13. Furthermore, the delay circuit 3111A is disposed between a signal line SL1 and the feedback line FBL and the delay circuit 3111B is disposed between a signal line SL2 and the feedback line FBL. The signal lines SL1 and SL2 connect the inverter-type amplifiers A11 to A13 together.

Here, the first signal generator 311 of this embodiment includes the inverter type amplifiers in an odd number of three or more. That is, three, five, seven or more of such amplifiers may be adopted in cascade.

For example, in a case where the first signal generator 311 has a three-stage amplifier structure of first, second and third amplifiers A11 to A13, the first inverter type amplifier All has a CMOS inverter structure with a P-MOS transistor M11 and an N-MOS transistor M12 connected in series, the second inverter type amplifier A12 has a CMOS inverter structure with a P-MOS transistor M21 and an N-MOS transistor M22 connected in series, and the third inverter type amplifier A13 also has a CMOS inverter structure with a P-MOS transistor M31 and an N-MOS transistor M32 connected in series.

Here, the first inverter type amplifier A11 has a supply voltage V_{DD} applied at a point where both the N-MOS transistor M11 and the P-MOS transistor M12 operate. Likewise, the second inverter type amplifier A12 has a supply voltage V_{DD} applied at a point where both the N-MOS transistor M21 and the P-MOS transistor M22 operate. Also the third inverter type amplifier A13 has a supply voltage V_{DD} applied at a point where both the N-MOS transistor M31 and the P-MOS transistor M32 operate. Consequently, each of the first, second and third inverter type amplifiers A11 to A13 are enabled by the supply voltage V_{DD}.

Moreover, the feedback circuit 111 includes at least one level damping resistor. Preferably, the feedback circuit 111 includes a plurality of level damping resistors R13 to R15 each disposed between the input terminal and the output terminal of the each inverter type amplifiers A11 to A13.

The level damping resistors R13 to R15 limits a level of an output signal which is fed back to the input terminal of the each amplifier A11 to A13, thereby preventing the overall level of the output signal from being fed back.

Each of the delay circuits 3111A and 3111B may be an RC circuit including a resistor and a capacitor. For example, the delay circuits 3111A and 3111B may be configured into an RC serial circuit, an RC parallel circuit or an RC serial and parallel circuit. Each of the delay circuits 3111A and 3111B of FIG. 5a is structured as an RC parallel circuit including the resistor R11 or R12 and the capacitor C11 or C12.

Further, referring to FIG. 5b, the second signal generator 312 of this embodiment includes a plurality of inverter-type amplifiers A21 to A23, a feedback circuit 121, and delay circuits 3121A and 3121B. The inverter-type amplifiers A21 to A23 are connected in series. The feedback circuit 121 has a feedback line FBL commonly connected to input terminals and output terminals of the inverter-type amplifiers A21 to A23. The delay circuit 3121A is disposed between a signal line SL1 and the feedback line FBL, and the delay circuit 3121B is disposed between a signal line SL2 and FBL. The signal lines SL1 and SL2 connect the inverter-type amplifiers A21 to A23 together.

Here, the second signal generator 312 of the invention includes the inverter type amplifiers in an odd number of three or more. That is, three, five, seven or more of such amplifiers may be adopted in cascade.

For example, in a case where the second signal generator 312 has a three-stage amplifier structure of first, second and third amplifiers A21 to A23, the first inverter type amplifier A21 has a CMOS inverter structure with a P-MOS transistor M41 and an N-MOS transistor M42 connected in series, the second inverter type amplifier A22 has a CMOS inverter structure with a P-MOS transistor M51 and an N-MOS transistor M52 connected in series, and the third inverter type amplifier A23 also has a CMOS inverter structure with a P-MOS transistor M61 and an N-MOS transistor M62 connected in series.

Here, the first inverter type amplifier A21 has a supply voltage VDD applied at a point where both the P-MOS transistor M41 and the N-MOS transistor M42 operate. Likewise, the second inverter type amplifier A22 has a supply voltage V_{DD} applied at a point where both the P-MOS transistor M51 and the N-MOS transistor M52 operate. Also, the third inverter type amplifier A23 has a supply voltage VDD applied at a point where both the P-MOS transistor M61 and the N-MOS transistor M62 operate. Consequently, each of the first, second and third inverter type amplifiers A21 to A23 is enabled by the supply voltage V_{DD}.

In addition, the feedback circuit 121 includes at least one level damping resistor. Preferably, the feedback circuit 121 includes a plurality of level damping resistors R23 to R25 each disposed between the input terminal and the output terminal of the each of the inverter type amplifiers A21 to A23.

The level damping resistors R23 to R25 limits a level of an output signal which is fed back to the input terminal of the each amplifier A21 to A23, thereby preventing the overall level of the output signal from being fed back.

Each of the delay circuits 3121A and 3121B may be an RC circuit including a resistor and a capacitor. For example, the delay circuits 3121A and 3121B may be configured into an RC serial circuit, an RC parallel circuit or an RC serial and parallel circuit. Each of the delay circuits 3121A and 3121B of FIG. 5b is structured as an RC parallel circuit including the resistor R21 or R22 and the capacitor C21 or C22.

In this fashion, the chaotic signal generator 31 is turned on when the supply voltage V_{DD} is applied. According to the invention, the supply voltage V_{DD} is supplied to or cut off from the chaotic signal generator by a supply voltage switch (reference sign 32 of FIG. 3) described below in detail.

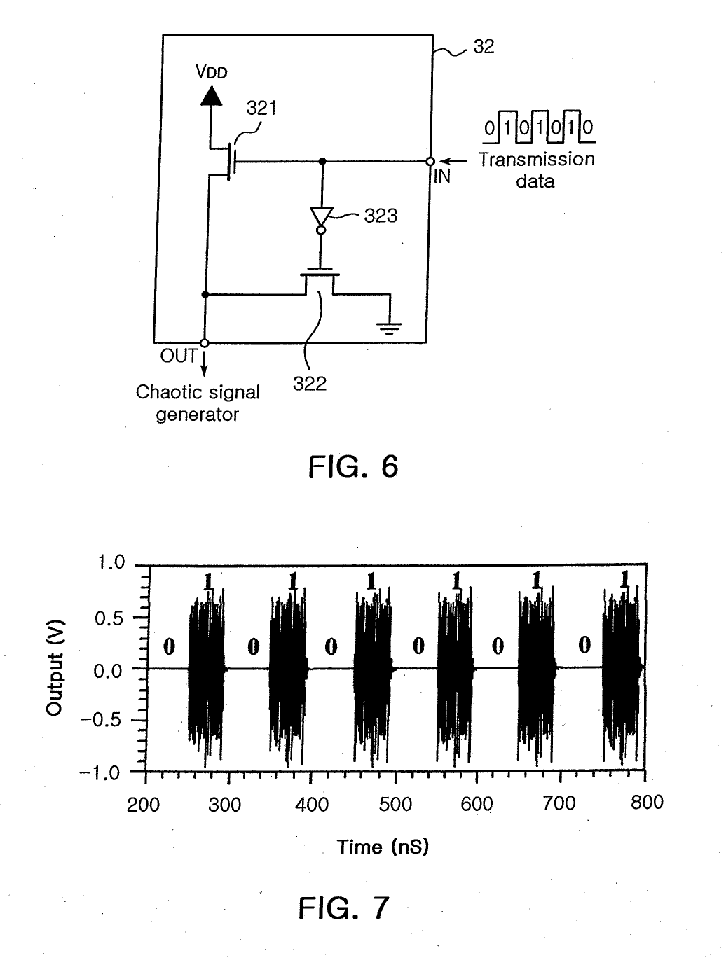

FIG. 6 is a detailed block diagram illustrating a supply voltage switch employed in the embodiment of the invention.

Referring to FIG. 6, the supply voltage switch 32 includes an input terminal IN, an output terminal OUT, a first transistor 321, a second transistor 322 and an inverter 323. The input terminal IN receives a digital transmission data. The output terminal OUT supplies a switched supply voltage V_{DD} to the chaotic signal generator (reference sign 31 of FIG. 3). The first transistor 321 has a gate connected to the input terminal IN, a drain connected to the supply voltage V_{DD} and a source connected to the output terminal OUT. Also, the second transistor 322 has a drain connected to the output terminal OUT and a source connected to a ground. The inverter 323 is connected between the input terminal IN and a gate of the second transistor 322.

The digital transmission data is a signal comprised of ‘0’ and ‘1’. In a case where ‘1’ is inputted to the input terminal IN of the supply voltage switch 32, the first transistor 321 of the supply voltage switch 32 is turned on and the second transistor 322 is turned off by the inverter 323. Thereby the supply voltage is supplied to the chaotic signal generator (reference sign 31 of FIG. 3) to turn on the chaotic signal generator. Meanwhile, in a case where ‘0’ is inputted to the input terminal IN of the supply voltage switch 32, the first transistor 321 is turned off and the second transistor 322 is turned on by the inverter 322. At this time, the supply voltage is not supplied to the chaotic signal generator so that the chaotic signal generator cannot be turned on, thereby outputting ‘0’. Especially, the second transistor 322 is connected to an input of the inverter, thus operating contrary to the first transistor 321. This quickly bypasses charges stored in a parasitic capacitor of a circuit at on/off of the second transistor 322, thereby getting the system free from any influences thereof.

In this fashion, when the transmission data is valued at ‘1’, the supply voltage switch 32 supplies the supply voltage V_{DD} to the chaotic signal generator to output a chaotic signal. Also, when the transmission data inputted is valued at ‘0’, the supply voltage V_{DD} is cut off from the chaotic signal generator so that an output from the chaotic signal generator is 0. That is, the chaotic signal generator (reference sign 31 of FIG. 3) is turned on when the transmission data is 1 and turned off when the transmission data is 0. This allows output of a signal which is the same as the transmission data modulated via OOK.

According to operations of the invention as just described, the chaotic signal generator achieves an output as shown in FIG. 7. In a case where the transmission data is ‘1’, a supply voltage is supplied to the chaotic signal generator to output a chaotic signal. Meanwhile, in a case where the transmission data is ‘0’, the supply voltage is cut off from the chaotic signal generator to output the chaotic signal of ‘0’. In the transmitter using the chaotic signal according to the invention, the chaotic signal generator is turned on only when an input value of the transmission data is ‘1’. This ensures a remarkable decrease in power consumption compared to a conventional chaotic signal generator which stays on continuously.

In addition, when an input value of the transmission data is ‘0’, the chaotic signal generator is not turned on at all, thereby precisely outputting ‘0’ as opposed to the conventional transmitter using the chaotic signal, which is sensitive to coupling.

Further, the invention solves a conventional problem of a spike phenomenon, which is caused by impedance changed by on/off of the chaotic signal generator. Referring back to FIG. 3, the transmitter using the chaotic signal according to this embodiment has a band pass filter 33a and an amplifier 33 formed integrally. In the description about this embodiment, hereinafter, such an integral filter/amplifier is referred to as ‘an integral amplifier having band pass filter properties’ and designated with reference sign 33.

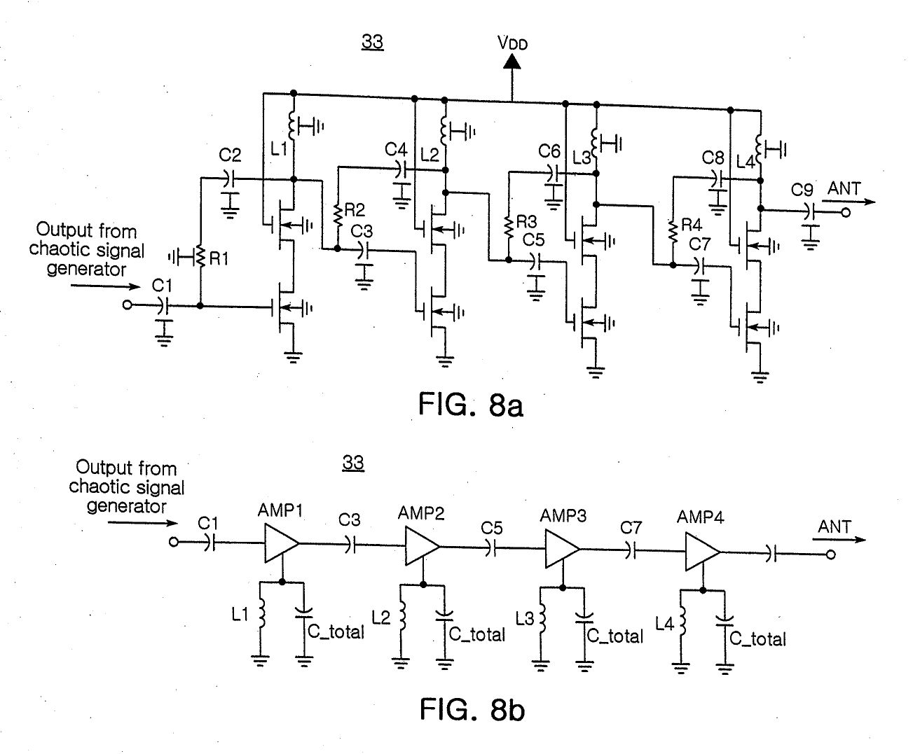

FIGS. 8a and 8b are detailed circuit diagrams and equivalent circuit diagrams illustrating an integral amplifier having band pass filter properties according to an embodiment of the invention. This embodiment illustrates a structure having four amplifiers connected in cascade, but the number of the amplifiers is not limitative of the invention.

Referring to FIGS. 8a and 8b, the integral amplifier 33 having band pass filter properties is structured as a cascode amplifier comprised of a plurality of amplifying stages. Each of the amplifying stages includes an amplifying part (one of AMP1 to AMP4) comprised of a transistor, and a band pass filter comprised of a capacitor (any of C1 to C9) and an inductor (one of L1 to L4) capacitively coupled to the amplifying part.

That is, as shown in FIG. 8b, the integral amplifier 33 having band pass filter properties according to this embodiment may be structured as a capacitively-coupled band pass filter having four poles. The inductor and capacitor of the each amplifying stage perform impedance matching and serve as a parallel resonator with a filter characteristic. The capacitor C total connected to the amplifying stage represents a sum of capacitance C2, C4, C6 and C8 for feeding back a signal of the each amplifying stage and parasitic capacitance such as drain capacitance of the transistor. In general, when a CMOS is configured with a band pass filter including an inductor and capacitor, characteristically the CMOS substrate suffers loss. Therefore, a passive device such as the inductor experiences power loss considerably and also a chip needs to be large-scale, with little applicability. Accordingly, an external chip filter with superior properties is adopted. Also, due to a significant factor of a unit price of filter in the overall product price, optionally a power amplifier is required to function as a filter and serve to amplify a signal in order to achieve lower chip price and miniaturization, as in the invention.

As set forth above, according to preferred embodiments of the invention, a chaotic signal generator is turned on only when an input value of a transmission data is ‘1’. This reduces power consumption considerably over a conventional chaotic signal generator.

Moreover, the chaotic signal generator is not turned on when the input value of the transmission data is ‘0’, thereby precisely outputting ‘0’, unaffected by coupling effects.

In addition, the invention does not employ a modulator, thereby eliminating a spike phenomenon which is induced by impedance changed by on/off of the modulator.

While the present invention has been shown and described in connection with the preferred embodiments, it will be apparent to those skilled in the art that modifications and variations can be made without departing from the spirit and scope of the invention as defined by the appended claims.

What is claimed is:

1. A transmitter using a chaotic signal for modulating a predetermined digital data to transmit, the transmitter comprising:
a chaotic signal generator for turning on to generate the chaotic signal when a supply voltage is supplied, and turning off when the supply voltage is cut off; and
a supply voltage switch for supplying/cutting off the supply voltage to/from the chaotic signal generator in accordance with the digital data;
wherein the supply voltage of the chaotic signal generator is supplied/cut off in accordance with the digital data so that an output from the chaotic signal generator is a modulated signal of the digital data.

2. The transmitter according to claim 1, wherein the chaotic signal generator comprises:
a plurality of signal generators each for generating a signal composed of a fundamental wave and a plurality of harmonic waves of the fundamental wave, the fundamental waves of the signal generators different from each other; and
a mixer for mixing the signals generated from the signal generator to generate a chaotic signal having a sum frequency of the signals and the harmonic waves of the signals.

3. The transmitter according to claim 1, wherein the supply voltage switch comprises:
an input terminal for receiving the digital data transmitted;
an output terminal for supplying a switched power supply to the chaotic signal generator;
a first transistor having a gate connected to the input terminal, a drain connected to the supply voltage and a source connected to the output terminal;
a second transistor having a drain connected to the output terminal and a source connected to a ground; and
an inverter connected between the input terminal and a gate of the second transistor.

4. The transmitter according to claim 1, further comprising:
a band pass filter for passing a signal component of a preset band out of the chaotic signal generated from the chaotic signal generator; and
an amplifier for amplifying the signal component at a given gain.

5. The transmitter according to claim 4, wherein the band pass filter is formed integrally with the amplifier.

6. The transmitter according to claim 5, wherein the integral structure of the band pass filter and amplifier comprises a cascode amplifier structure including a plurality of amplifying stages,
wherein each of the amplifying stages comprises an amplifying part including a transistor, and a band pass filtering part including a capacitor and an inductor capacitively coupled to the amplifying part.
